(19) United States
(12) Patent Application Publication
(10) Pub. No.: US 2024/0421341 A1
(43) Pub. Date: Dec. 19, 2024

(54) POWER STORAGE CELL AND METHOD OF PRODUCING THE SAME

(71) Applicant: TOYOTA JIDOSHA KABUSHIKI KAISHA, Toyota-shi (JP)

(72) Inventors: Takeshi Abe, Okazaki-shi (JP); Ryuta Sugiura, Toyota-shi (JP); Tomoyuki Uezono, Okazaki-shi (JP); Takenori Ikeda, Owariasahi-shi (JP); Yuki Takahashi, Miyoshi-shi (JP); Kenta Kimura, Toyota-shi (JP)

(73) Assignee: TOYOTA JIDOSHA KABUSHIKI KAISHA, Toyota-shi (JP)

(21) Appl. No.: 18/636,641

(22) Filed: Apr. 16, 2024

(30) Foreign Application Priority Data
Jun. 15, 2023 (JP) 2023-098377

(51) Int. Cl. H01M 10/04; H01M 50/107

(52) U.S. Cl. CPC H01M 10/0431; H01M 10/0422; H01M 10/049; H01M 50/107

(57) ABSTRACT

A power storage cell comprises a cell case and a wound electrode assembly. The wound electrode assembly includes a first electrode, a separator, a second electrode, and a fixing member. In a winding direction of the wound electrode assembly, the first electrode has a first end portion. The second electrode has a second end portion. The separator has a third end portion. In the winding direction, the second end portion is positioned within a region spanning from the first end portion to the third end portion. The first end portion consists of the first foil. The second end portion consists of the second foil. The fixing member fixes the wound electrode assembly at the third end portion. The expression “0.9×T2≤Tf≤1.1×(T1+T2)” is satisfied. T1 represents a thickness of the first foil. T2 represents a thickness of the second foil. Tf represents a maximum thickness of the fixing member.

### CROSS REFERENCE TO RELATED APPLICATIONS

This nonprovisional application is based on Japanese Patent Application No. 2023-098377 filed on Jun. 15, 2023, with the Japan Patent Office, the entire contents of which are hereby incorporated by reference.

### BACKGROUND OF THE DISCLOSURE

### Field

The present disclosure relates to a power storage cell and a method of producing the same.

### Description of the Background Art

International Patent Laying-Open No. WO 2019/111742 discloses a tape for fixing an end-of-winding part of a wound electrode assembly.

### SUMMARY OF THE DISCLOSURE

A power storage cell may comprise a cylindrical case and a wound electrode assembly. The cylindrical case accommodates the wound electrode assembly. In a cross section orthogonal to the axial direction of the cylindrical case, the interior wall of the cylindrical case is circular. In the same cross section, the contour of the wound electrode assembly is substantially circular as well. However, the roundness of the wound electrode assembly is lower than the roundness of the cylindrical case. When the interior wall of the cylindrical case comes into contact with the wound electrode assembly, stress is generated. Due to the lower roundness of the wound electrode assembly, concentration of stress can occur.

An object of the present disclosure is to reduce stress concentration.

Hereinafter, the technical configuration and effects of the present disclosure will be described. It should be noted that the action mechanism includes presumption. The action mechanism does not limit the technical scope of the present disclosure.

1. A power storage cell according to an aspect of the present disclosure includes the following configuration.

The power storage cell comprises a cell case and a wound electrode assembly.

The cell case is cylindrical. The cell case accommodates the wound electrode assembly. The wound electrode assembly includes a first electrode, a separator, a second electrode, and a fixing member. The first electrode includes a first foil. The second electrode includes a second foil. In a winding direction of the wound electrode assembly, the first electrode has a first end portion. The second electrode has a second end portion. The separator has a third end portion. In the winding direction, the second end portion is positioned within a region spanning from the first end portion to the third end portion. The first end portion consists of the first foil. The second end portion consists of the second foil. The fixing member fixes the wound electrode assembly at the third end portion.

The fixing member satisfies a relationship of the following expression.

$$0.9 \times T 2 \leq Tf \leq 1.1 \times ( T 1 + T 2 )$$

In the above formula, T1 represents a thickness of the first foil. T2 represents a thickness of the second foil. Tf represents a maximum thickness of the fixing member.

In the wound electrode assembly, the first end portion is the end of winding of the first electrode. The first end portion consists of the first foil. The second end portion is the end of winding of the second electrode. The second end portion consists of the second foil. Hereinafter, “electrode foil” collectively refers to the first foil and the second foil. In the winding direction, at least part of the fixing member is positioned outside from the first end portion and outside from the second end portion. At the end of winding of the wound electrode assembly, the thickness of the electrode foil and the thickness of the fixing member may form a level difference. It is conceivable that when a large level difference is formed, the roundness of the wound electrode assembly may decrease.

For example, when the second end portion is close to the first end portion, the degree of level difference may change depending on the relationship between the total thickness of the first foil and the second foil, (T1+T2), and the maximum thickness of the fixing member, (Tf). Conventionally, the maximum thickness of the fixing member, (Tf), is sufficiently larger than the total thickness (T1+T2). In an aspect of the present disclosure, the maximum thickness of the fixing member is equivalent to or less than the total thickness of the first foil and the second foil. More specifically, the maximum thickness of the fixing member, (Tf), is 1.1×(T1+T2) or less. With the maximum thickness of the fixing member being equivalent to or less than the total thickness of the first foil and the second foil, the level difference is expected to be reduced. With the level difference reduced, the roundness is expected to be improved.

For example, when the second end portion is far from the first end portion, the degree of level difference may change depending on the relationship between the thickness of the second foil, (T2), and the maximum thickness of the fixing member, (Tf). In an aspect of the present disclosure, the maximum thickness of the fixing member is equivalent to or more than the thickness of the second foil. More specifically, the maximum thickness of the fixing member, (Tf), is 0.9×T2 or more. With the maximum thickness of the fixing member being equivalent to or more than the thickness of the second foil, the level difference is expected to be reduced. With the level difference reduced, the roundness is expected to be improved. In an aspect of the present disclosure, with the roundness improved, stress concentration is expected to be reduced.

Here, “maximum thickness” refers to the thickness of the thickest part of the fixing member. The thickness of the fixing member may be uniform, or may vary. When the thickness of the fixing member is uniform, the fixing member is regarded as having the maximum thickness across its entirety.

The expression “within a region” includes both ends of the region. More specifically, “an aspect where in the winding direction, the second end portion is positioned within a region spanning from the first end portion to the third end portion” includes “an aspect where in the winding direction, the position of the second end portion is the same as the position of the first end portion” and “an aspect where in the winding direction, the position of the second end portion is the same as the position of the third end portion”.

2. The power storage cell according to “1” above may include the following configuration, for example.

The fixing member further satisfies a relationship of the following expression.

$$0.9 \times T 2 \leq Tf \leq 1.1 \times T 2$$

For example, when the second end portion is far from the first end portion, and if the maximum thickness of the fixing member, (Tf), is close to the thickness of the second foil, (T2), the level difference is expected to be reduced. For example, the maximum thickness of the fixing member, (Tf), may be 0.9 to 1.1 times the thickness of the second foil, (T2).

3. The power storage cell according to “2” above may include the following configuration, for example.

In a cross section orthogonal to an axis of winding of the wound electrode assembly, an angle formed by a first half line and a second half line is greater than 30°. Each of an endpoint of the first half line and an endpoint of the second half line is a center of winding. The first half line passes the first end portion. The second half line passes the second end portion.

When the angle formed in “3” above is greater than 30°, and if the maximum thickness of the fixing member is close to the thickness of the second foil, the level difference is expected to be reduced.

4. The power storage cell according to “1” above may include the following configuration, for example.

The fixing member further satisfies a relationship of the following expression.

$$0.9 \times ( T 1 + T 2 ) \leq Tf \leq 1.1 \times ( T 1 + T 2 )$$

For example, when the second end portion is close to the first end portion, and if the maximum thickness of the fixing member, (Tf), is close to the total thickness of the first foil and the second foil, (T1+T2), the level difference is expected to be reduced. For example, the thickness of the fixing member, (Tf), may be 0.9 to 1.1 times the total thickness (T1+T2).

5. The power storage cell according to “4” above may include the following configuration, for example.

In a cross section orthogonal to an axis of winding of the wound electrode assembly, an angle formed by a first half line and a second half line is 30° or less. Each of an endpoint of the first half line and an endpoint of the second half line is a center of winding. The first half line passes the first end portion. The second half line passes the second end portion.

When the angle formed in “5” above is 30° or less, and if the maximum thickness of the fixing member is close to the total thickness of the first foil and the second foil, the level difference is expected to be reduced.

6. The power storage cell according to any one of “1” to “5” above may include the following configuration, for example.

The fixing member has a first edge and a second edge. In the winding direction, the first edge is a starting edge of the fixing member. In the winding direction, the second edge is located opposite to the first edge. The fixing member has a maximum thickness at the first edge.

In the winding direction, the starting edge of the fixing member may be close to the electrode foil. With the fixing member having the maximum thickness at the starting edge, the level difference is expected to be reduced.

7. The power storage cell according to “6” above may include the following configuration, for example.

At least a part between the first edge and the second edge, a thickness of the fixing member decreases in a direction from the first edge toward the second edge.

Hereinafter, the aspect of “7” above is also called “inclination”. With the fixing member being provided with inclination, the roundness is expected to be improved, for example.

8. The power storage cell according to any one of “1” to “7” above may include the following configuration, for example.

The first electrode is a positive electrode. The second electrode is a negative electrode.

9. A method of producing a power storage cell according to an aspect of the present disclosure comprises the following (a) and (b):
(a) forming a wound electrode assembly; and
(b) placing the wound electrode assembly into a cell case to produce a power storage cell.

The cell case is cylindrical. The wound electrode assembly includes a first electrode, a separator, a second electrode, and a fixing member. The first electrode includes a first foil. The second electrode includes a second foil. In a winding direction of the wound electrode assembly, the first electrode has a first end portion. The second electrode has a second end portion. The separator has a third end portion. In the winding direction, the second end portion is positioned within a region spanning from the first end portion to the third end portion. The first end portion consists of the first foil. The second end portion consists of the second foil. The fixing member fixes the wound electrode assembly at the third end portion.

The fixing member satisfies a relationship of the following expression.

$$0.9 \times T 2 \leq Tf \leq 1.1 \times ( T 1 + T 2 )$$

In the above formula, T1 represents a thickness of the first foil. T2 represents a thickness of the second foil. Tf represents a maximum thickness of the fixing member.

10. The method of producing a power storage cell according to “9” above may include the following configuration, for example.

The fixing member further satisfies a relationship of the following expression.

$$0.9 \times T 2 \leq Tf \leq 1.1 \times T 2$$

11. The method of producing a power storage cell according to “9” above may include the following configuration, for example.

The fixing member further satisfies a relationship of the following expression.

$$0.9 \times ( T 1 + T 2 ) \leq Tf \leq 1.1 \times ( T 1 + T 2 )$$

12. The method of producing a power storage cell according to any one of “9” to “11” above may include the following configuration, for example.

The fixing member is affixed to the third end portion to fix the wound electrode assembly. The fixing member has a first edge and a second edge. In the winding direction, the first edge is a starting edge of the fixing member. In the winding direction, the second edge is located opposite to the first edge. Affixation of the fixing member is started from the first edge. During at least one period of time from beginning of the affixation of the fixing member to completion of the affixation, tension applied to the fixing member is increased.

For example, the tension during the process of affixation may be changed to provide inclination to the fixing member.

13. The method of producing a power storage cell according to any one of “9” to “12” above may include the following configuration, for example.

The first electrode is a positive electrode. The second electrode is a negative electrode.

In the following, an embodiment of the present disclosure (which may also be simply called “the present embodiment” hereinafter) will be described. It should be noted that the present embodiment does not limit the technical scope of the present disclosure. The present embodiment is illustrative in any respect. The present embodiment is non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a first schematic cross-sectional view illustrating an example of a power storage cell according to the present embodiment.

FIG. 2 is a second schematic cross-sectional view illustrating an example of a power storage cell according to the present embodiment.

FIG. 3 is a schematic cross-sectional view illustrating a first example of an end-of-winding part according to the present embodiment.

FIG. 4 is a schematic cross-sectional view illustrating a second example of an end-of-winding part according to the present embodiment.

FIG. 5 is a schematic cross-sectional view illustrating a third example of an end-of-winding part according to the present embodiment.

FIG. 6 is a schematic cross-sectional view illustrating a fourth example of an end-of-winding part according to the present embodiment.

FIG. 7 is a schematic cross-sectional view illustrating a fifth example of an end-of-winding part according to the present embodiment.

FIG. 8 is a schematic cross-sectional view illustrating a sixth example of an end-of-winding part according to the present embodiment.

FIG. 9 is a schematic cross-sectional view illustrating an example of a fixing member according to the present embodiment.

FIG. 10 is a schematic flowchart illustrating a method of producing a power storage cell according to the present embodiment.

FIG. 11 is a graph showing an example of changes of tension according to the present embodiment.

FIG. 12 is a schematic cross-sectional view illustrating an example of a cutting position on an electrode raw sheet.

### DESCRIPTION OF THE PREFERRED EMBODIMENTS

### 1. Terms

Terms such as “comprise”, “include”, and “have”, and other similar terms are open-ended terms. In an open-ended term, in addition to an essential component, an additional component may or may not be further included. The term “consist of” is a closed-end term. However, in a configuration that is expressed by a closed-end term, impurities present under ordinary circumstances as well as an additional element irrelevant to the technique according to the present disclosure are encompassed. The term “consist essentially of” is a semiclosed-end term. A semiclosed-end term tolerates addition of an element that does not substantially affect the fundamental, novel features of the technique according to the present disclosure.

Expressions such as “may” and “can” are not intended to mean “must” (obligation) but rather mean “there is a possibility” (tolerance).

Any geometric term should not be interpreted solely in its exact meaning. Examples of geometric terms include “parallel”, “vertical”, “orthogonal”, and the like. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. Further, a part of a given configuration may have been omitted.

A numerical range such as “from m to n %” includes both ends, unless otherwise specified. That is, “from m to n %” means a numerical range of “not less than m % and not more than n %”. “Not less than m % and not more than n %” includes “more than m % and less than n %”. “Not less than” and “not more than” are represented by an inequality symbol with an equality symbol, e.g., “≤”. “More than” and “less than” are represented by an inequality symbol without an equality symbol, e.g., “<”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

### 2. Power Storage Cell

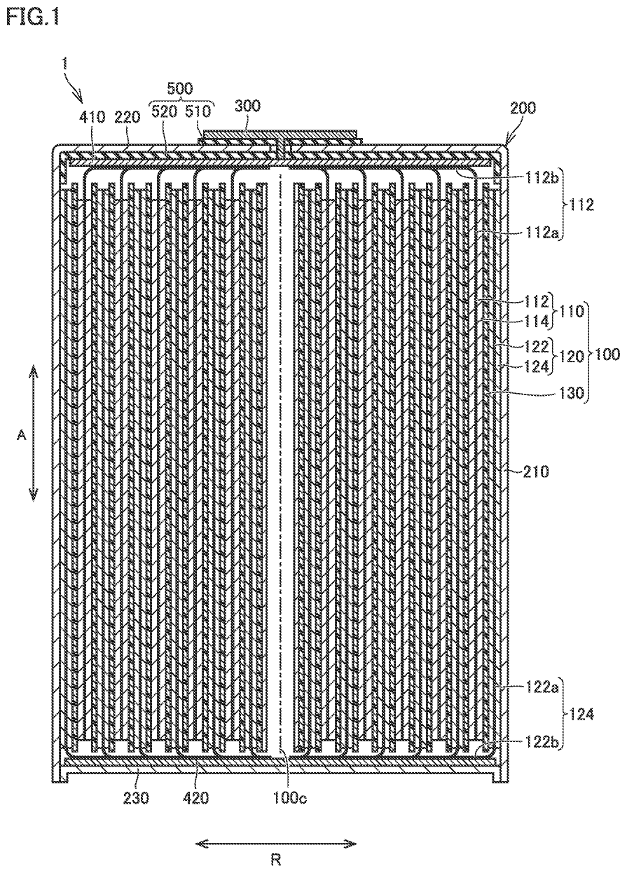

FIG. 1 is a first schematic cross-sectional view illustrating an example of a power storage cell according to the present embodiment. A power storage cell 1 is cylindrical. Power storage cell 1 may be applied to any purpose of use. For example, power storage cell 1 may be used as a power supply for vehicles, and the like. Power storage cell 1 includes a cell case 200 and a wound electrode assembly 100. Power storage cell 1 may further include an electrolyte solution (not illustrated), an external terminal 300, a first current collector plate 410, a second current collector plate 420, an insulating member 500, and the like, for example.

### 2-1. Wound Electrode Assembly

In FIG. 1, a cross section parallel to the axis of winding is illustrated. The axis of winding is a straight line formed by centers of winding 100c aligned in the axial direction. “Axial direction” is the direction A in FIG. 1. Wound electrode assembly 100 includes a first electrode 110, a separator 130, a second electrode 120, and a fixing member 140. The polarity of second electrode 120 is different from that of first electrode 110. For example, first electrode 110 may be a positive electrode. For example, second electrode 120 may be a negative electrode. For example, first electrode 110 may be a negative electrode. For example, second electrode 120 may be a positive electrode.

Each of first electrode 110 and second electrode 120 is an electrode having a belt-like shape. Each of first electrode 110, second electrode 120, and separator 130 is in sheet form. For example, first electrode 110, separator 130, and second electrode 120 may be stacked in this order to form a stack. The resulting stack may be spirally wound to form wound electrode assembly 100.

First electrode 110 includes a first foil 112 and a first active material layer 114. First foil 112 may function as a current collector. For example, first foil 112 may include Al, Cu, Ni, Fe, Ti, and/or the like. First foil 112 includes a first region 112a and a second region 112b. In first region 112a, first active material layer 114 is placed. First active material layer 114 includes a positive electrode active material or a negative electrode active material. For example, the positive electrode active material may include lithium-nickel composite oxide and/or the like. For example, the negative electrode active material may include graphite, Si, SiO, and/or the like. Second region 112b is adjacent to first region 112a. Second region 112b is positioned at an edge in the axial direction. Second region 112b has a plurality of tabs. The tabs are separated from each other in the circumferential direction of wound electrode assembly 100. For example, the tabs may be welded to second region 112b. For example, a part of second region 112b may be made into a tab. Each tab leans inwardly in the radial direction. “Radial direction” is the direction R in FIG. 1 and the like. The outer surface of each tab is substantially flat. Each tab is connected to first current collector plate 410. Each tab may be welded to first current collector plate 410.

Second electrode 120 includes a second foil 122 and a second active material layer 124. Second foil 122 may function as a current collector. For example, second foil 122 may include Al, Cu, Ni, Fe, Ti, and/or the like. Second foil 122 includes a first region 122a and a second region 122b. In first region 122a, second active material layer 124 is placed. Second active material layer 124 includes a positive electrode active material or a negative electrode active material. Second region 122b is adjacent to first region 122a. Second region 122b is positioned at an edge in the axial direction. Second region 122b has a plurality of tabs. The tabs are separated from each other in the circumferential direction of wound electrode assembly 100. Each tab leans inwardly in the radial direction. The outer surface of each tab is substantially flat. Each tab is connected to second current collector plate 420. Each tab may be welded to second current collector plate 420.

Separator 130 is electrically insulating. Separator 130 electrically separates first electrode 110 from second electrode 120. Separator 130 is positioned between first electrode 110 and second electrode 120 in the radial direction. Separator 130 is porous. The electrolyte solution is capable of permeating into separator 130. For example, separator 130 may include a resin porous film and/or the like. For example, the electrolyte solution may include a lithium salt, an organic solvent, and the like.

### 2-2. Fixing Member

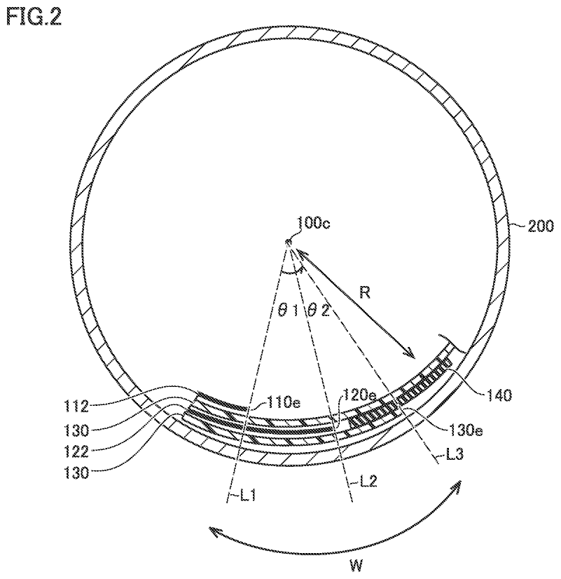

FIG. 2 is a second schematic cross-sectional view illustrating an example of a power storage cell according to the present embodiment. In FIG. 2, a cross section orthogonal to the axis of winding is illustrated. “Winding direction” is the direction W in FIG. 2. In the winding direction, first electrode 110 has a first end portion 110e. First end portion 110e is the end of winding of first electrode 110. Second electrode 120 has a second end portion 120e. Second end portion 120e is the end of winding of second electrode 120. Separator 130 has a third end portion 130e. Third end portion 130e is the end of winding of separator 130. In the winding direction, second end portion 120e is positioned within a region spanning from first end portion 110e to third end portion 130e. At first end portion 110e, first foil 112 is exposed from first active material layer 114. First foil 112 by itself forms first end portion 110e. That is, first end portion 110e consists of first foil 112. At second end portion 120e, second foil 122 is exposed from second active material layer 124. Second foil 122 by itself forms second end portion 120e. That is, second end portion 120e consists of second foil 122.

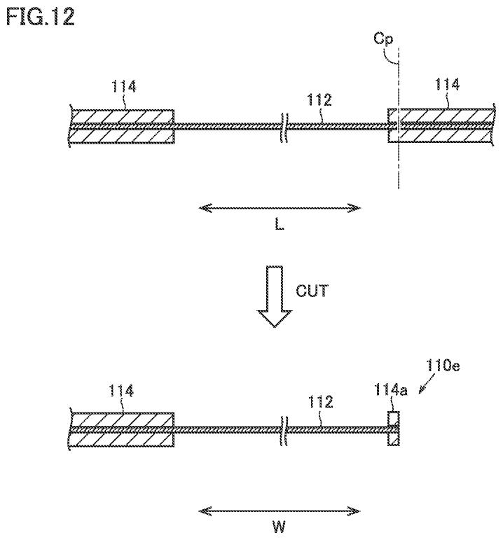

FIG. 12 is a schematic cross-sectional view illustrating an example of a cutting position on an electrode raw sheet. For example, first end portion 110e may consist essentially of first foil 112. In a configuration where first end portion 110e consists essentially of first foil 112, a first fragment 114a may be present at the tip of first end portion 110e. First fragment 114a is a part of first active material layer 114. For example, in the longitudinal direction of the electrode raw sheet, on a surface of first foil 112, first active material layers 114 may be formed in a non-continuous pattern. “Longitudinal direction” is the direction L in FIG. 12. The longitudinal direction is the winding direction of wound electrode assembly 100. The electrode raw sheet is cut into individual first electrodes 110. For example, from the viewpoint of material efficiency and the like, a cutting position Cp may be set inside first active material layer 114. After cutting, first fragment 114a may be left on the tip of first end portion 110e. First fragment 114a may be present on only one side of first foil 112. First fragment 114a may be present on both sides of first foil 112. For example, the length of first fragment 114a may be 5 mm or less, or 4 mm or less, or 3 mm or less, or 2 mm or less, or 1 mm or less. The length of first fragment 114a may be 0.001 mm or more, or 0.01 mm or more, or 0.05 mm or more, or 0.1 mm or more, or 0.5 mm or more, or 1 mm or more. The configuration of first end portion 110e is substantially the same as the configuration of second end portion 120e. Second end portion 120e may consist essentially of second foil 122. At the tip of second end portion 120e, a second fragment (not illustrated) may be present. The second fragment is a part of second active material layer 124.

For example, fixing member 140 may include adhesive tape and/or the like. For example, fixing member 140 may be affixed to third end portion 130e. With the presence of fixing member 140, wound electrode assembly 100 retains its structure without coming loose. In other words, fixing member 140 fixes wound electrode assembly 100 at third end portion 130e.

### (1) Maximum Thickness

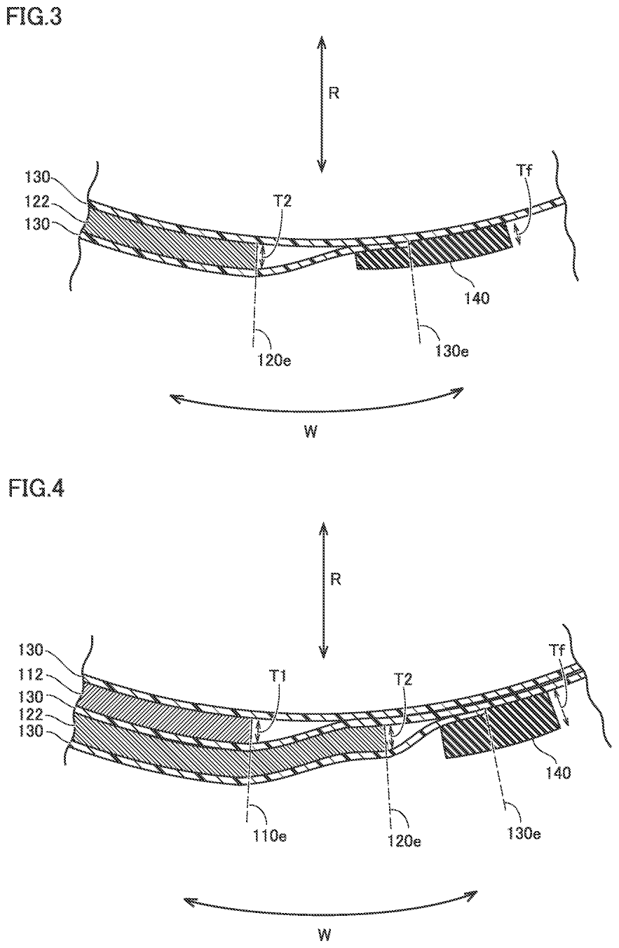

FIG. 3 is a schematic cross-sectional view illustrating a first example of an end-of-winding part according to the present embodiment. In the first example, second end portion 120e is far from first end portion 110e. In the first example, depending on the relationship between the thickness of second foil 122, (T2), and the maximum thickness of fixing member 140, (Tf), the level difference may be reduced. More specifically, the maximum thickness (Tf) is 0.9×T2 or more. With the maximum thickness (Tf) being 0.9×T2 or more, the level difference is expected to be reduced. For example, the maximum thickness (Tf) of the fixing member may be 1.1×T2 or less. For example, the maximum thickness (Tf) of the fixing member may be equal to the thickness of second foil 122, (T2).

FIG. 4 is a schematic cross-sectional view illustrating a second example of an end-of-winding part according to the present embodiment. In the second example, as compared to the first example, second end portion 120e is close to first end portion 110e. In the second example, depending on the relationship between the total thickness of first foil 112 and second foil 122, (T1+T2), and the maximum thickness of fixing member 140, (Tf), the level difference may be reduced. More specifically, the maximum thickness (Tf) is 1.1×(T1+T2) or less. With the maximum thickness (Tf) being 1.1×(T1+T2) or less, the level difference is expected to be reduced. For example, the maximum thickness (Tf) may be 0.9×(T1+T2) or more. For example, the maximum thickness (Tf) may be equal to the total thickness (T1+T2).

In a configuration in which first fragment 114a is present at the tip of first end portion 110e (see FIG. 12), the sum of the thickness of first foil 112 and the thickness of first active material layer 114 is regarded as T1. In a configuration where the second fragment is present at the tip of second end portion 120e, the sum of the thickness of second foil 122 and the thickness of second active material layer 124 is regarded as T2.

It is conceivable that as second end portion 120e comes closer to first end portion 110e, the structure of the end-of-winding part shifts from the first example (FIG. 3) to the second example of (FIG. 4). In the course of shifting, with the maximum thickness (Tf) being from 0.9×T2 to 1.1×(T1+T2), the level difference is expected to be reduced. Hence, fixing member 140 satisfies the relationship of the following expression.

$$0.9 \times T 2 \leq Tf \leq 1.1 \times ( T 1 + T 2 )$$

For example, fixing member 140 may satisfy the relationship of the following expression.

$$T 2 \leq Tf \leq ( T 1 + T 2 )$$

For example, fixing member 140 may satisfy the relationship of the following expression.

$$0.9 \times T 2 \leq Tf \leq 1.1 \times T 2$$

For example, fixing member 140 may satisfy the relationship of the following expression.

$$0.9 \times ( T 1 + T 2 ) \leq Tf \leq 1.1 \times ( T 1 + T 2 )$$

For example, fixing member 140 may satisfy the relationship of the following expression.

$$0.4 \times ( T 1 + T 2 ) \leq Tf \leq 0.6 \times ( T 1 + T 2 )$$

For example, fixing member 140 may satisfy the relationship of the following expression.

$$0.6 \times ( T 1 + T 2 ) \leq Tf \leq 0.9 \times ( T 1 + T 2 )$$

For example, fixing member 140 may satisfy the relationship of the following expression.

$$0.1 \times ( T 1 + T 2 ) \leq Tf \leq 0.4 \times ( T 1 + T 2 )$$

For example, each of the thickness of first foil 112, (T1), and the thickness of second foil 122, (T2), may be independently from 5 to 100 μm, or from 5 to 50 μm, or from 5 to 30 μm, or from 5 to 20 μm, or from 5 to 15 μm. For example, the thickness of each member, (T1, T2, Tf), may be measured with a constant-pressure thickness-measuring instrument and/or the like.

### (2) Angle

The degree of how far second end portion 120e is from first end portion 110e may be evaluated in terms of a first angle θ1 in FIG. 2, for example. First angle θ1 is an angle formed by a first half line L1 and a second half line L2. First angle θ1 is a positive angle. First half line L1 is the initial side, and second half line L2 is a radius vector. “Positive angle” is an angle that is formed by the radius vector moving, from the initial side, in the direction from the starting edge toward the ending edge in the winding direction. Each of the endpoint of first half line L1 and the endpoint of second half line L2 is the center of winding 100c. “Center of winding” refers to the geometric center of a shape formed by the contour of wound electrode assembly 100. First half line L1 passes first end portion 110e. Second half line L2 passes second end portion 120e.

For example, first angle θ1 may be greater than 30°. When first angle θ1 is greater than 30°, and if the maximum thickness of fixing member 140, (Tf), is close to the thickness of second foil 122, (T2), the level difference is expected to be reduced. For example, first angle θ1 may be 45° or more, or 60° or more, or 90° or more, or 120° or more, or 150° or more, or 180° or more, or 210° or more, or 240° or more, or 270° or more, or 300° or more, or 330° or more. For example, first angle θ1 may be 360° or less, or 330° or less, or 300° or less, or 270° or less, or 240° or less, or 210° or less, or 180° or less, or 150° or less, or 120° or less, or 90° or less, or 60° or less, or 45° or less.

For example, first angle θ1 may be 30° or less. When first angle θ1 is 30° or less, and if the maximum thickness of fixing member 140, (Tf), is close to the total thickness of first foil 112 and second foil 122, (T1+T2), the level difference is expected to be reduced. For example, first angle θ1 may be 25° or less, or 20° or less, or 15° or less, or 10° or less, or 5° or less, or 3° or less, or 1° or less. For example, first angle θ1 may be 0° or more, or 1° or more, or 3° or more, or 5° or more, or 10° or more, or 15° or more, or 20° or more, or 25° or more.

When first angle θ1 is 0°, the position of second end portion 120e is the same as the position of first end portion 110e in the winding direction.

The degree of how far third end portion 130e is from second end portion 120e may be evaluated in terms of a second angle θ2 in FIG. 2, for example. Second angle θ2 is an angle formed by second half line L2 and a third half line L3. Second angle θ2 is a positive angle. Second half line L2 is the initial side, and third half line L3 is the radius vector. The endpoint of third half line L3 is also the center of winding 100c. Third half line L3 passes third end portion 130e.

For example, second angle θ2 may be 0° or more, or 1° or more, or 3° or more, or 5° or more, or 10° or more, or 15° or more, or 30° or more, or 45° or more, or 60° or more, or 90° or more, or 120° or more, or 150° or more, or 180° or more, or 210° or more, or 240° or more, or 270° or more, or 300° or more, or 330° or more. For example, second angle θ2 may be 360° or less, or 330° or less, or 300° or less, or 270° or less, or 240° or less, or 210° or less, or 180° or less, or 150° or less, or 120° or less, or 90° or less, or 60° or less, or 45° or less, or 30° or less, or 15° or less, or 10° or less, or 5° or less, or 3° or less, or 1° or less.

When second angle θ2 is 0°, the position of second end portion 120e is the same as the position of third end portion 130e in the winding direction.

### (3) Position

As long as it is possible to fix third end portion 130e, the position of fixing member 140 is not particularly limited. For example, as illustrated in FIG. 3 and the like, a part of fixing member 140 may overlap third end portion 130e. In other words, at least part of fixing member 140 may be positioned outside from separator 130 (the outermost layer) in the radial direction. “Radial direction” is the direction R in FIG. 3 and the like.

FIG. 5 is a schematic cross-sectional view illustrating a third example of an end-of-winding part according to the present embodiment. For example, at least part of fixing member 140 may be positioned inside of separator 130 (the outermost layer) in the radial direction.

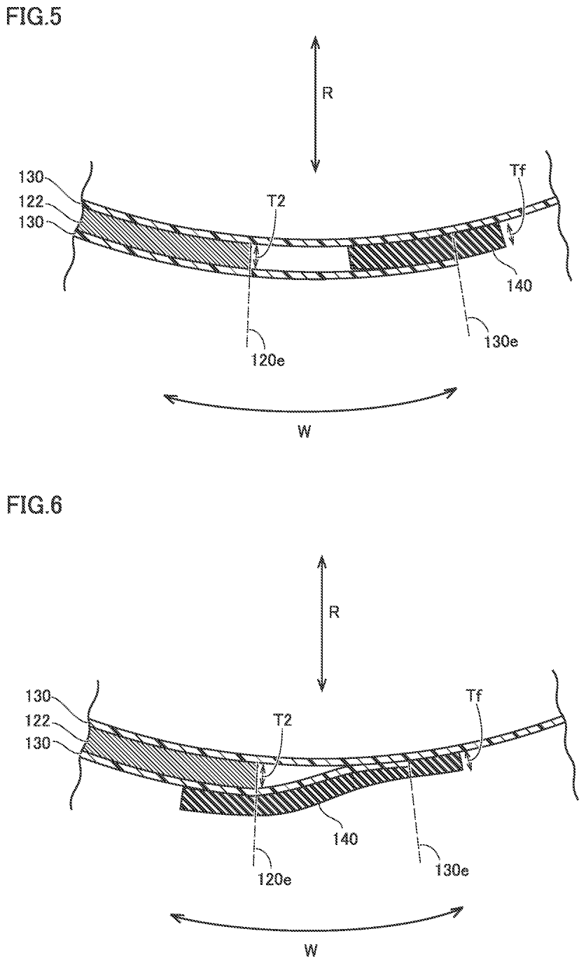

FIG. 6 is a schematic cross-sectional view illustrating a fourth example of an end-of-winding part according to the present embodiment. For example, at least part of fixing member 140 may overlap the electrode foil. For example, at least part of fixing member 140 may overlap second foil 122. At least part of fixing member 140 may overlap both the first foil 112 and the second foil 122.

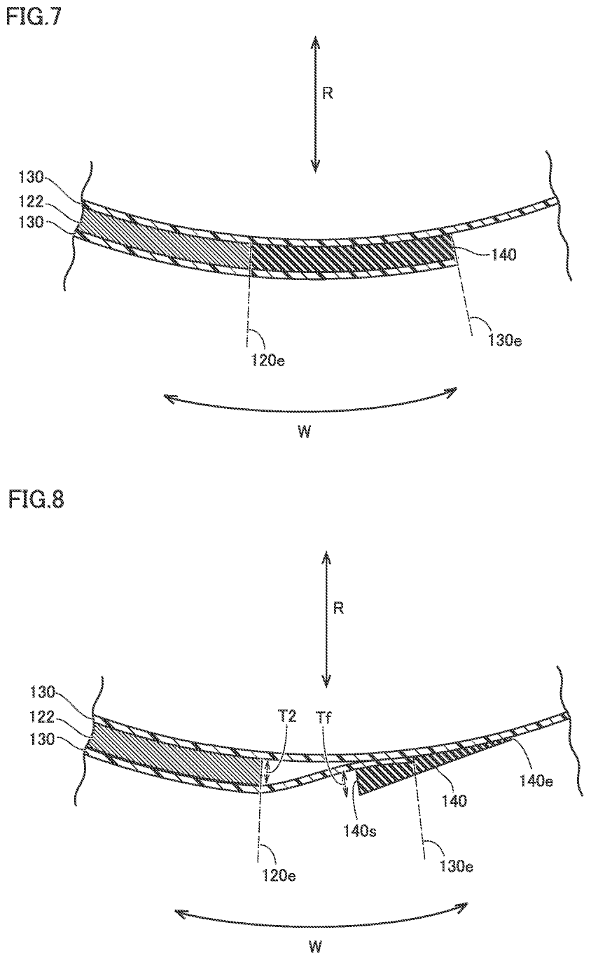

FIG. 7 is a schematic cross-sectional view illustrating a fifth example of an end-of-winding part according to the present embodiment. For example, inside of the outermost layer, fixing member 140 may be adjacent to the electrode foil. For example, fixing member 140 may be in contact with second foil 122. There may be a gap between fixing member 140 and the electrode foil. Fixing member 140 may not necessarily extend beyond third end portion 130e in the winding direction.

### (4) Inclination

FIG. 8 is a schematic cross-sectional view illustrating a sixth example of an end-of-winding part according to the present embodiment. Fixing member 140 has a first edge 140s and a second edge 140e. In the winding direction, first edge 140s is the starting edge of fixing member 140. Second edge 140e is the ending edge of fixing member 140. Second edge 140e is located opposite to first edge 140s. In the winding direction, the thickness of fixing member 140 may be substantially uniform, for example. “Substantially uniform” means that the ratio of the maximum thickness to the minimum thickness is from 1 to 1.2. For example, the ratio of the maximum thickness to the minimum thickness may be from 1 to 1.1, or from 1 to 1.05. For example, fixing member 140 may have the maximum thickness at first edge 140s. With fixing member 140 having the maximum thickness at first edge 140s, the level difference is expected to be reduced.

Fixing member 140 may have inclination. More specifically, at at least a part between first edge 140s and second edge 140e, the thickness of fixing member 140 may decrease in a direction from first edge 140s to second edge 140e. With fixing member 140 having inclination, the roundness is expected to be improved. Fixing member 140 may have inclination across its entirety. That is, fixing member 140 may have the maximum thickness at first edge 140s. Fixing member 140 may have the minimum thickness at second edge 140e. “Minimum thickness” refers to the thickness of the thinnest part of fixing member 140.

For example, the thickness of fixing member 140 may change continuously. For example, the thickness of fixing member 140 may decrease continuously from first edge 140s toward second edge 140e. For example, the thickness may decrease linearly. For example, the thickness may decrease at a certain rate. For example, the thickness may decrease non-linearly. For example, the thickness may decrease stepwise. For example, the thickness may decrease at a rate of exponential function.

### (5) Base Material Layer, Adhesive Layer

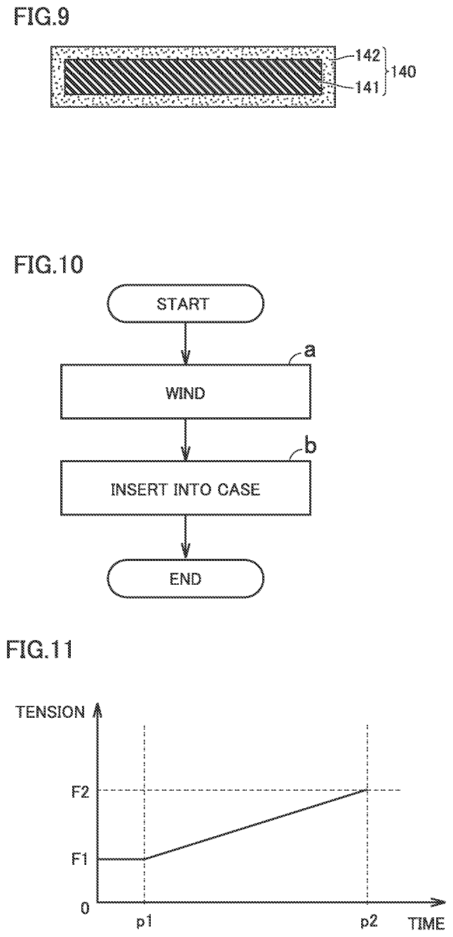

FIG. 9 is a schematic cross-sectional view illustrating an example of a fixing member according to the present embodiment. As long as it is possible to fix wound electrode assembly 100, fixing member 140 may have any configuration. For example, fixing member 140 may include a base material layer 141 and an adhesive layer 142. For example, base material layer 141 may have a substantially uniform thickness across its entirety. At least part of base material layer 141 may have inclination. Adhesive layer 142 may have a substantially uniform thickness across its entirety. At least part of adhesive layer 142 may have inclination.

For example, fixing member 140 may be electrically insulating. For example, base material layer 141 may include at least one selected from the group consisting of polypropylene (PP), polyimide (PI), polyethylene (PE), polyethylene terephthalate (PET), and polyphenylene sulfide (PPS). For example, adhesive layer 142 may include at least one selected from the group consisting of acrylic-based adhesive material, silicone-based adhesive material, urethane-based adhesive material, and rubber-based adhesive material.

For example, fixing member 140 may consist of adhesive layer 142. For example, adhesive layer 142 may include at least one selected from the group consisting of vinyl-acetate-resin-based emulsion-form adhesive agent, acrylic-resin-based emulsion-form adhesive agent, vinyl-acetate-resin-based solvent-form adhesive agent, acrylic-resin-based solvent-form adhesive agent, vinyl-chloride-resin-based solvent-form adhesive agent, chloroprene-rubber-based solvent-form adhesive agent, chloroprene-rubber-based solvent-form mastic-type adhesive agent, nitrile-rubber-based solvent-form adhesive agent, urethane-resin-based adhesive agent, epoxy-resin-based adhesive agent, modified-silicone-resin-based adhesive agent, epoxy-modified-silicone-resin-based adhesive agent, starch-based adhesive agent, polymer-cement mortar, epoxy resin mortar, and silylated-urethane-resin-based adhesive agent.

### 2-3. Cell Case

Cell case 200 accommodates wound electrode assembly 100. For example, cell case 200 may be made of metal. For example, cell case 200 may include Fe, stainless steel, and/or the like. Cell case 200 is cylindrical. Cell case 200 includes a circumferential wall 210, a top wall 220, and a bottom wall 230. Circumferential wall 210 is cylindrical. Circumferential wall 210 surrounds the outer circumferential surface of wound electrode assembly 100. Circumferential wall 210 may be in contact with the outer circumferential surface of wound electrode assembly 100.

Top wall 220 is connected to an end of circumferential wall 210 in the axial direction. For example, at the center of top wall 220, a through hole may be formed for connection to external terminal 300. In the axial direction, bottom wall 230 faces top wall 220. Bottom wall 230 is connected to an end of circumferential wall 210 in the axial direction. Bottom wall 230 is in contact with second current collector plate 420.

External terminal 300 is provided on the outer surface of top wall 220. The polarity of external terminal 300 is different from the polarity of cell case 200. For example, external terminal 300 may have positive polarity. For example, cell case 200 may have negative polarity. For example, external terminal 300 may have negative polarity. For example, cell case 200 may have positive polarity.

Insulating member 500 electrically separates external terminal 300 from cell case 200. Insulating member 500 includes a first insulating portion 510 and a second insulating portion 520. First insulating portion 510 is present between external terminal 300 and top wall 220. Inside of cell case 200, second insulating portion 520 is present between first current collector plate 410 and cell case 200.

### 3. Method of Producing Power Storage Cell

FIG. 10 is a schematic flowchart illustrating a method of producing a power storage cell according to the present embodiment. Hereinafter, “the method of producing a power storage cell according to the present embodiment” may also be simply called “the present production method”. The present production method includes “(a) winding” and “(b) inserting into a case”.

### 3-1. (a) Winding

The present production method includes forming wound electrode assembly 100. Details of wound electrode assembly 100 are as described above. First electrode 110, second electrode 120, separator 130, and fixing member 140 are prepared. A single separator 130 may be used alone, or two or more separators 130 may be used. For example, four members, namely first electrode 110, separator 130, second electrode 120, and separator 130 may be stacked to form a stack. The resulting stack may be spirally wound to form wound electrode assembly 100. Fixing member 140 may be affixed to third end portion 130e of separator 130 to fix wound electrode assembly 100. The stack formation and the stack winding may be carried out either sequentially or simultaneously.

For example, the present production method may include providing inclination to fixing member 140. For example, during the process of affixation of fixing member 140, tension applied to fixing member 140 may be changed.

FIG. 11 is a graph showing an example of changes of tension according to the present embodiment. From a first time point p1, affixation is started. At first time point p1, first edge 140s of fixing member 140 is made to adhere to separator 130. Fixing member 140 is gradually affixed from first edge 140s. At a second time point p2, second edge 140e of fixing member 140 is made to adhere to separator 130. At second time point p2, affixation is completed.

For example, at at least one period of time between first time point p1 and second time point p2, tension may be increased. Due to the increase of tension, fixing member 140 may be provided with inclination. For example, at first time point p1, a first tension F1 is provided. At second time point p2, a second tension F2 is provided. Second tension F2 is greater than first tension F1. For example, the ratio of second tension F2 to first tension F1, (F2/F1), may be 1.1 or more, or 1.2 or more, or 1.5 or more, or 2 or more. For example, the ratio (F2/F1) may be 2 or less, or 1.5 or less, or 1.2 or less, or 1.1 or less. For example, the increase of tension may be continuous. For example, from first time point p1 to second time point p2, tension may be increased at a certain rate. For example, the increase of tension may be in stages. For example, from first time point p1 to second time point p2, tension may be increased stepwise. For example, from first time point p1 to second time point p2, tension may be increased at a rate of exponential function.

3-2. (b) Inserting into Case

The present production method includes placing wound electrode assembly 100 into cell case 200 to produce power storage cell 1. Wound electrode assembly 100 is inserted into cell case 200 in such a manner that the axis of winding of wound electrode assembly 100 becomes parallel to the axial direction of cell case 200. First electrode 110 is electrically connected to external terminal 300. Second electrode 120 is electrically connected to cell case 200. After wound electrode assembly 100 is inserted, the electrolyte solution may be injected into cell case 200. Cell case 200 is hermetically sealed to complete power storage cell 1. Bottom wall 230 may be welded to circumferential wall 210 by laser and the like, for example.

What is claimed is:

1. A power storage cell comprising:
a cell case; and
a wound electrode assembly, wherein
the cell case is cylindrical,
the cell case accommodates the wound electrode assembly,
the wound electrode assembly includes a first electrode, a separator, a second electrode, and a fixing member,
the first electrode includes a first foil,
the second electrode includes a second foil,
in a winding direction of the wound electrode assembly, the first electrode has a first end portion, the second electrode has a second end portion, and the separator has a third end portion,
in the winding direction, the second end portion is positioned within a region spanning from the first end portion to the third end portion,
the first end portion consists of the first foil,
the second end portion consists of the second foil,
the fixing member fixes the wound electrode assembly at the third end portion, and
the fixing member satisfies a relationship of the following expression:
$$0.9 \times T 2 \leq Tf \leq 1.1 \times ( T 1 + T 2 )$$
where
T1 represents a thickness of the first foil,
T2 represents a thickness of the second foil, and
Tf represents a maximum thickness of the fixing member.

2. The power storage cell according to claim 1, wherein the fixing member further satisfies a relationship of the following expression:
$$0.9 \times T 2 \leq Tf \leq 1.1 \times T 2.$$

3. The power storage cell according to claim 2, wherein
in a cross section orthogonal to an axis of winding of the wound electrode assembly,
an angle formed by a first half line and a second half line is greater than 30°,
each of an endpoint of the first half line and an endpoint of the second half line is a center of winding,
the first half line passes the first end portion, and
the second half line passes the second end portion.

4. The power storage cell according to claim 1, wherein the fixing member further satisfies a relationship of the following expression:
$$0.9 \times ( T 1 + T 2 ) \leq Tf \leq 1.1 \times ( T 1 + T 2 ) .$$

5. The power storage cell according to claim 4, wherein
in a cross section orthogonal to an axis of winding of the wound electrode assembly,
an angle formed by a first half line and a second half line is 30° or less,
each of an endpoint of the first half line and an endpoint of the second half line is a center of winding,
the first half line passes the first end portion, and
the second half line passes the second end portion.

6. The power storage cell according to claim 1, wherein
the fixing member has a first edge and a second edge,
in the winding direction, the first edge is a starting edge of the fixing member,
in the winding direction, the second edge is located opposite to the first edge, and
the fixing member has a maximum thickness at the first edge.

7. The power storage cell according to claim 6, wherein at at least a part between the first edge and the second edge, a thickness of the fixing member decreases in a direction from the first edge toward the second edge.

8. The power storage cell according to claim 1, wherein
the first electrode is a positive electrode, and
the second electrode is a negative electrode.

9. A method of producing a power storage cell, the method comprising:
(a) forming a wound electrode assembly; and
(b) placing the wound electrode assembly into a cell case to produce a power storage cell, wherein
the cell case is cylindrical,
the wound electrode assembly includes a first electrode, a separator, a second electrode, and a fixing member,
the first electrode includes a first foil,
the second electrode includes a second foil,
in a winding direction of the wound electrode assembly, the first electrode has a first end portion, the second electrode has a second end portion, and the separator has a third end portion,
in the winding direction, the second end portion is positioned within a region spanning from the first end portion to the third end portion,
the first end portion consists of the first foil,
the second end portion consists of the second foil,
the fixing member fixes the wound electrode assembly at the third end portion, and
the fixing member satisfies a relationship of the following expression:
$$0.9 \times T 2 \leq Tf \leq 1.1 \times ( T 1 + T 2 )$$
where
T1 represents a thickness of the first foil,
T2 represents a thickness of the second foil, and
Tf represents a maximum thickness of the fixing member.

10. The method of producing a power storage cell according to claim 9, wherein the fixing member further satisfies a relationship of the following expression:
$$0.9 \times T 2 \leq Tf \leq 1.1 \times T 2.$$

11. The method of producing a power storage cell according to claim 9, wherein the fixing member further satisfies a relationship of the following expression:
$$0.9 \times ( T 1 + T 2 ) \leq Tf \leq 1.1 \times ( T 1 + T 2 ) .$$

12. The method of producing a power storage cell according to claim 9, wherein
the fixing member is affixed to the third end portion to fix the wound electrode assembly,
the fixing member has a first edge and a second edge,
in the winding direction, the first edge is a starting edge of the fixing member,
in the winding direction, the second edge is located opposite to the first edge,
affixation of the fixing member is started from the first edge, and
during at least one period of time from beginning of the affixation of the fixing member to completion of the affixation, tension applied to the fixing member is increased.

13. The method of producing a power storage cell according to claim 9, wherein
the first electrode is a positive electrode, and
the second electrode is a negative electrode.
